(19) United States
(12) Patent Application Publication
(10) Pub. No.: US 2001/0037308 A1
(43) Pub. Date: Nov. 1, 2001

(54) Fully secure identification and transmission system

(76) Inventor: Mark Kotlarsky, Potomac, MD (US)

Correspondence Address: Mark Kotlarsky, 11610 Piney Spring Lane, Potomac, MD, 20854, US

(21) Appl. No.: 09/681,390

(22) Filed: Mar. 28, 2001

Related U.S. Application Data
(60) Provisional application No. 60/192,524, filed on Mar. 28, 2000.

(51) Int. Cl. H04K 1/00; H04L 9/00; G06F 17/60

(52) U.S. Cl. 705/64

(57) ABSTRACT

A system and apparatus for creating and administering fully secure identification procedures, to ensure that informational or transactional messages are sent over the network by authorized persons and for transmitting fully secure messages and files over an unsecure networks. A recipient of the message requests the sender to initiate the secure identification procedure using the sender's secure identification apparatus and, simultaneously, notifies the verification station that the request was initiated. The sender identifies himself or herself to the authority via the secure identification apparatus and the authority notifies the recipient whether the identification process was completed successfully by issuing an identification certificate. In addition, the sender may use a modified apparatus to send an encrypted and hashed message (any file in any agreed upon format) to the verification station. The message is encrypted by the modified apparatus and is decrypted by the verification station. The decrypted message contains the information necessary to forward the message to the recipient. The verification station re-encrypts and hashes the message using encryption that may be decoded only by the recipient's modified apparatus. The system relies on user-provided physical security (denial of access to the apparatus), utilizes single use certificates and the “one time pad” encryption mechanism to eliminate the possibility of electronic theft.

### CROSS REFERENCE TO RELATED APPLICATIONS

Priority is hereby claimed to Provisional Patent Application No. 60/192,524 filed in the name of Mark Kotlarsky on Mar. 28, 2000, entitled Fully Secure Identification and Transmission System.

### BACKGROUND OF THE INVENTION

Herein, the term “network” refers to any electronic communications network, including but not limited to the Internet, “Intranets”, various wide area networks (WANs) and local area networks (LANs). The term “transaction” refers to any transfer of information between any computers in the network. These transactions may be used in a variety of applications such as e-mail, data exchange, electronic commerce, and legal communications.

The person sending a “transaction” is referred to as “Customer” and the person receiving the “transaction” is referred to as “Merchant”. A Customer may be an individual, a business or a location of a business or entity, while a Merchant may be another individual, a business or another location of the same business.

The term “Identification Certificate” means information issued by a “Verification station”, an entity which supplies the secure identification apparatus and which is trusted by the network's participants, to verify that a particular person initiated a transaction.

The Internet network provides connection among a large and growing number of entities including vendors of goods and services and their potential customers. Incentives to conduct business over the network are many and compelling, for example, the reduction or elimination of the need for physical travel, samples, and sales personnel in the selling process and the centralized provision of the latest product or services descriptions and terms, allowing inexpensive, uniform and timely updates at the point of sale. Using the Internet, small businesses can communicate with an audience of customers far beyond that previously available to them. For these and many other reasons, business is being conducted in increasingly large volumes over the Internet and other networks.

However, there are limitations and problems associated with sales and other transactions over the network. From the Merchants' point of view, the fundamental concern is how to verify the identity of a party to a transaction, particularly in a transaction that results in the transfer of value to the party. From the Customers' point of view the fundamental concern is the protection from an identity theft and transfers of value from a Customer's account to any other person.

In the world of paper transactions, Customers are protected by law. For instance, if a person fraudulently signs a check in another's name, the bank is fully responsible for protecting the owner of the account. The law also limits a Customer's liability due to a credit card theft or unauthorized use to $50. However, if an electronic thief obtains access to the owner's bank account electronically and transfers funds, the owner has no protection at all under the law. Therefore, Customers have a pressing need to protect their financial well being against electronic theft.

Similarly, in the world of physical delivery of tangible goods, merchants could protect themselves against credit card fraud by delivering goods only to the credit card owner's registered address. In the world of electronic communications, this protection may be unavailable to a merchant selling services, software or information and such merchant must assure itself of the identity of the purchaser before the transaction is consummated. In addition, even though the laws of electronic transactions seem to favor merchants, it is likely that any merchant may face difficulties in enforcing the terms of an electronic transaction consummated by an identity thief. In summary, the ability of both Merchants and Customers to protect themselves from electronic theft is fundamental to the future of network commerce.

In addition, it is frequently necessary to send highly sensitive information over the network, either from one business entity to another or from one location to another location of the same entity. The information may be so sensitive that even the location of the recipient may need to be protected.

Maintaining electronic security of a network is a difficult and arduous task. A Customer cannot be expected to have software, resource or skills to assure that his computer is secure from an electronic intrusion, especially when the computer is permanently connected to the network and is not monitored. Consequently, and critically important, is the concept that a fully secure identification and transmission system would prevent an electronic identity thief from impersonating a Customer even if the thief has total control over the Customer's network computer.

The system must protect the Customer even if the thief can monitor any entry made on the keyboard, can intercept any transmission and can transmit any message from the Customer's computer. In addition, the system must be relatively inexpensive to install and operate. Finally, the system must also allow a Customer to transmit highly sensitive information over the network in such a manner that an intruder which has total control over the Customer's network computer is unable to obtain highly sensitive information transmitted over the network. For this purpose, the term “highly sensitive information” is defined to include the name of the recipient.

Presently, there are three basic approaches to assuring the identity of parties to a transaction and providing a basis for non-repudiation of a transaction in a network environment: password protection, the employment therein of an electronic certification procedure, and the use of so-called “smart cards”. None of these systems satisfies all of the above requirements. Any system built exclusively around password protection is inherently unreliable, due to the possibility of electronic theft of the password, even if the thief simply intercepts the password message and then emulates the password from another computer.

A better approach is built upon a public/private key or “asymmetric” encryption/decryption scheme defined, for example, in the ANSI X9.30 series of specifications covering “the Digital Signature Algorithm”. The concept is based upon the existence of algorithms that allow encryption/decryption using related “keys” that are associated with each other, but one of which, the “private” key, is difficult to derive from the other, “public” key. This system is vulnerable on two fronts: first, a thief controlling the Customer's computer will be able to learn the password before the password is encrypted and, second, the encryption code may be broken within days, if not hours, by anybody who has access to the public key and understanding of the message components. Even if the thief cannot obtain access to or control over the Customer's computer, an encryption/decryption system would be fully secure only if the Customer changes its password every day (or even once every couple of hours).

The smart card system may provide a fully secure system, because it relies on physical security without the physical card, one is not allowed to access the Merchant. This system works well over a proprietary network, such as the ATM network, because (i) one access node can serve numerous users; and (ii) the network's security is maintained solely by the merchant. However, an implementation of any “smart card” system over a public network appears to be impractical; it is unlikely that Customers will be willing to purchase very expensive smart card readers. Furthermore, this system requires either secure communication with the card reader to avoid electronic emulation or additional electronic security measures. Thus, the smart card system appears to be unrealistic for widespread use.

Thus, there are no existing practical fully secure methods of sending sensitive information over the network.

### SUMMARY OF INVENTION

The present invention offers a novel security system that prevents user passwords from being intercepted and interpreted at the entry point or during transmission over a network. In accordance with a preferred embodiment of the present invention, the system will perform in the following manner.

There are three parties to each transaction under this system: Customer, Merchant and Verification station. The Customer obtains the identification apparatus (“Apparatus”) from the Verification station prior to entering into any transaction protected by the system. The Customer contacts the Merchant on the network and orders an electronic transaction through the Merchant's ordinary login procedure, which may or may not require a password (e.g., purchases a product or service, transfers money from a bank account, instructs a broker to buy or sell stock, etc.). When the Customer notifies the Merchant that his order is complete, the Merchant's computer sends a request to the Customer to identify himself using the Apparatus. Simultaneously, the Merchant's computer sends a notice to the Verification station that an identification request has been sent to the Customer. The Customer identifies himself, using the apparatus, which sends an encrypted message to the Verification station. The Verification station verifies the content of the message and sends a verification messages both to the Customer and the Merchant that the person correctly identified himself. The Merchant then completes the transaction.

### BRIEF DESCRIPTION OF DRAWINGS

FIG. 1 is a block data flow diagram, on a global level, of the present invention.

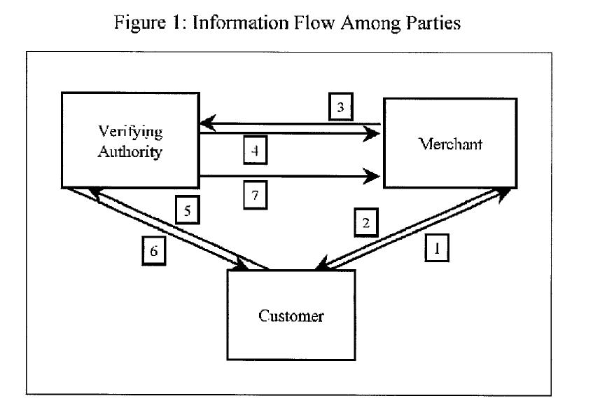

FIG. 2 is a block data flow diagram, on the Customer's site level, of the present invention.

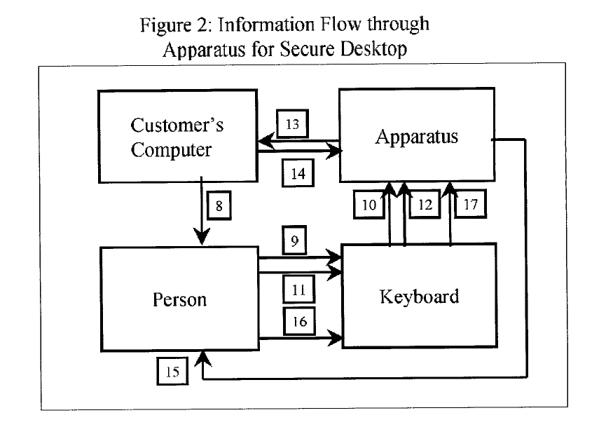

FIG. 3 is a block diagram of the apparatus of the present invention.

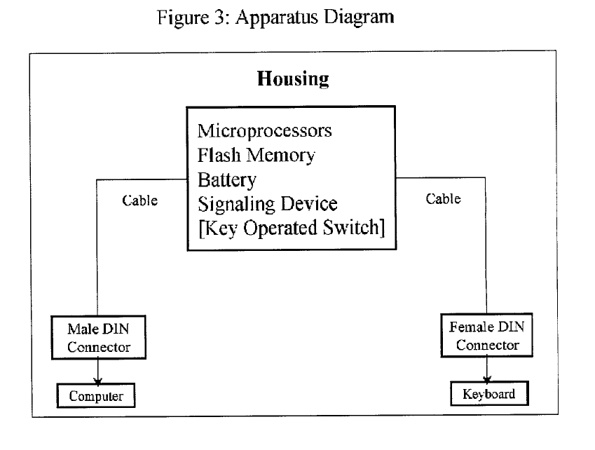

FIG. 4 is a block diagram of the user interface of the present invention.

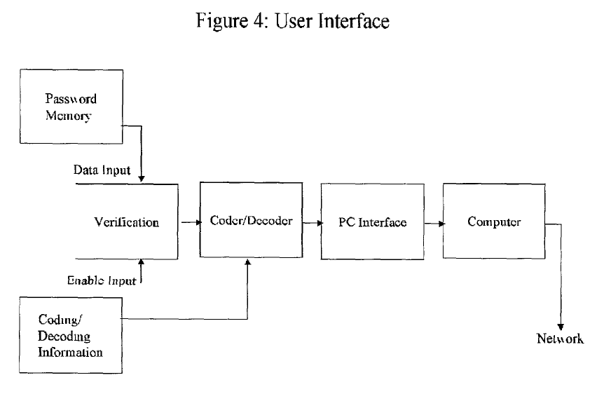

FIG. 5 is a block diagram of the receiving station of the present invention.

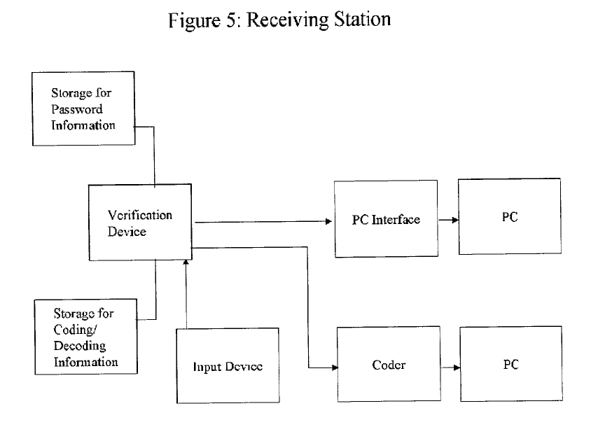

FIG. 6 is a block diagram of showing the overview of the present invention.

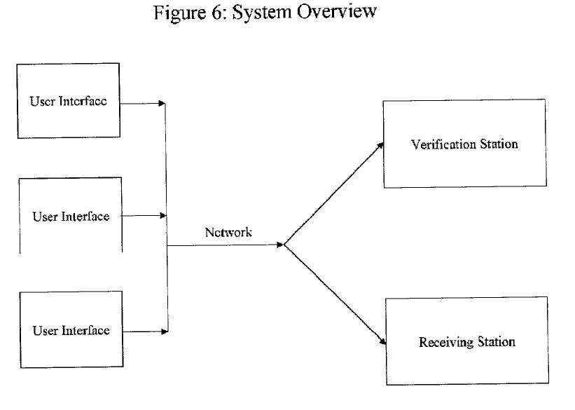

### DETAILED DESCRIPTION

The Apparatus is implemented in three versions: desktop version for secure locations (i.e., home), desktop version for unsecure locations, and laptop version. Additional versions may be appropriate for older computers not utilizing the ports discussed below. Another additional version is appropriate for transmission of highly sensitive data over an unsecure network where the transmitting data station is secure. The present invention can be constructed of any conventional means available, and employs conventional hardware in all aspects of the system.

The desktop version for secure locations will consist of an electronic device that consists of a preprogrammed microprocessor, flash memory, a signaling device (beeper or a light for hearing impaired) and connecting cables with a male and a female DIN connector. The cables connect the device to the keyboard port of the computer on the one end and to the keyboard on the other end. Under normal conditions, the device scans the entries on the keyboard, but simply allows the keyboard's own processor to communicate directly with the computer. The device's microprocessor is activated upon receipt of a designated set of entries on the keyboard. After this set of entries has been received, the microprocessor prevents the signals received from the keyboard controller from reaching the computer and prompts the accompanying software program to ask the Customer to enter and re-enter his password on the keyboard. The password is then verified.

If the password is correct, it is encrypted and the encrypted entry and additional accompanying information is then forwarded to the Verification station. The Verification station authenticates the entry and returns a verification command to the Customer's computer, where it is transmitted to the Apparatus. The Apparatus verifies that the confirmation message is correct, and prompts the software to instruct the Customer to key in the sequence to turn off the Apparatus. The Apparatus then becomes inactive until next use.

If the password is incorrect, the Apparatus originates a security breach procedure: it issues an encrypted security breach code to the Verification station. The Verification station notifies the Merchant that the identification procedure has failed and initiates a back-up security notice to the Customer based on the agreed upon procedures. If the Apparatus receives an incorrect verifying message from the Verification station, it notifies the Customer that the Customer's security is breached by beeping (or flashing light for hearing impaired). In neither case an electronic thief controlling the Customer's computer will know that the Customer is aware of the security breach.

The Apparatus desktop version for unsecure locations is essentially the same as that for secure locations, except that it is activated, not by a sequence of commands, but by a physical lock and key. Depending on the Customer's needs, this key can be a relatively simple mechanical lock, a high-security lock or an electronic lock with a chip embedded in the key.

The Apparatus for laptop computers is significantly different than that for desktops, since the keyboard connection in a laptop is not routinely useraccessible. Instead, the Apparatus is a PC Card with an attached number pad. Because laptops by definition are not kept in secure locations, the laptop Apparatus will be activated by an electronic key.

The Customer is responsible for basic security by denying unauthorized access to the physical Apparatus and keys, if any. The Customer is also responsible for protecting the password. The Apparatus maintains a high level of electronic security as follows: the password is never entered into the computer, and cannot be intercepted by any person via electronic means. When a password is entered into the Apparatus, it is encrypted by using a simple, unbreakable, one-time pad encryption mechanism, which changes with every request for identification. The Verification station has a conversion table for each Customer's apparatus; the conversion tables are different for each Apparatus.

As a result, an electronic thief attempting to intercept a signal will not be able to decrypt the password, and, even if the password is somehow decrypted or stolen, will not be able to emulate the password successfully on the next request. Additional security is provided for the laptop and unsecured desktop by equipping the Apparatus with a key to prevent unauthorized use.

This link in the communication chain can be totally non-secure. However, because the information transmitted cannot be decrypted, security is not required. It is only required that the Customer receive a notification from the Verification station that the identification verification message has been received. This message is also encrypted using a series of one-time pad codes, changing with each request. If the message is not received, the Customer is alerted as to the security breach.

The Verification station provides its own physical and electronic security, to ensure that no unauthorized person gains access to any information available to the Verification station.

This invention does not require the Merchant to take any specific security measures. The Merchant is expected to maintain normal computer security. In particular, the Merchant must maintain sufficient level of security to be able to verify that its messages to the Verification station are received by the Verification station.

The link between the Verification station and the Merchant must be relatively secure to ensure, first, that each message is actually received and, second, that the content of each message was not tampered with by an intruder. To ensure secure operations, each message will be encrypted and hashed, using a continuously changing public-private key encryption system and the receipt of each message will be confirmed using the same system. The messages may be decrypted by an intruder, but the content of the message cannot be changed en route. Other security methods as known in the art may be used to ensure the security of the communications between the Verification station and the Merchant.

A fully secure transmission system requires a modified identification apparatus, which, in addition to the features described above, includes an appropriate capacity removable disc storage device (e.g., a floppy disc drive, a ZIP drive or a similar high capacity drive) and a cable connecting the modified apparatus to a high-speed computer port (e.g., USB port). If a Customer wishes to send highly sensitive information to a Merchant (which may be any other business or a different location of the same business), the Customer first prepares the information on a separate computer, not connected to the network. Because this computer is not connected to the network, the Customer can be assured that this computer is totally secure by denying physical access to the computer.

The Customer then adds routing information and saves the information on a removable disc. The disc is then inserted in the modified apparatus and the modified apparatus is activated. The modified apparatus then hashes and encrypts the information, and further transfers the encrypted information to the computer connected to the network. The information is encrypted by using an unbreakable, one-time pad encryption mechanism, which changes with every request for fully secure transmission. This computer then transmits the encrypted file to the Verification station.

The Verification station decrypts the message. The decrypted message contains the information necessary to forward the message to the recipient. The Verification station re-encrypts and hashes the message using encryption that may be decoded only by the Merchant's modified apparatus. To prevent identification of the recipient based on the length of the message, a random number of meaningless bytes is added to the message. The message is then sent to the Merchant. The Verification station also notifies the Customer that the information was received by the Merchant.

If the transmitting station is secure, the Apparatus may be imbedded in the station and not be external to the station.

It will now be apparent to those skilled in the art that other embodiments, improvements, details and uses can be made consistent with the letter and spirit of the foregoing disclosure and within the scope of this patent, which is limited only by the following claims, construed in accordance with the patent law, including the doctrine of equivalents.

1. a method for conducting secure communication, comprising:
communicating a purchase request from first location to a second location;
communicating a first identification request from said second location to said first location;
communicating a second identification request from said second location to a third location;
communicating a third identification request from said first location to said third location; and
communicating a confirmation of identification from said third location to said first location and said second location.

2. The method of claim 1, wherein said third identification request is encrypted.

3. The method of claim 1, wherein said third identification request is produced by using a system of pad encryptions.

4. The method of claim 3, wherein said system of pad encryptions is employed only once.

5. The method of claim 1, wherein said confirmation of identification is encrypted.

6. The method of claim 1, wherein said confirmation of identification is encrypted using a public/private key encryption system.

7. The method of claim 1, wherein said confirmation of identification is produced by using a system of pad encryptions.

8. The method of claim 7, wherein said system of pad encryptions is employed only once.

9. The method of claim 1, wherein said first location has a computer.

10. The method of claim 9, wherein said purchase request originates from said computer.

11. The method of claim 1, wherein said first location has an authentication device.

12. The method of claim 11, wherein said third identification request originates from said authentication device.

13. The method of claim 11, wherein said authentication device has microprocessors, an information storage capacity, a power source, and connecting devices.

14. The method of claim 11, wherein said authentication device has an input device.

15. The method of claim 11, wherein said authentication device has an output device.

16. A security system for providing exchange of secure information through a network, comprising:
at least one user interface coupled to the network for producing the secure information;
at least one receiving station coupled to the network for receiving a message from said at least one user interface; and
a verification station, coupled to the network, for receiving the secure information from said at least one user interface, and for transmitting a verification signal to said at least one receiving station to verify identity of said at least one user interface.

17. The system of claim 16, wherein said at least one user interface has a computing device interfaced to the network.

18. The system of claim 1 7, wherein said at least one user interface has an encoding device external with respect to said computing device.
